(19) United States
(12) Patent Application Publication
(10) Pub. No.: US 2020/0189526 A1
(43) Pub. Date: Jun. 18, 2020

(54) METHOD FOR OPERATING A CAPACITIVE RAIN SENSOR OF A MOTOR VEHICLE, MEASUREMENT SIGNAL INTERFERENCE SUPPRESSION DEVICE, AND MOTOR VEHICLE COMPRISING SUCH A MEASUREMENT SIGNAL INTERFERENCE SUPPRESSION DEVICE

(71) Applicant: AUDI AG, Ingolstadt (DE)

(72) Inventor: Jens NACHTIGALL, Ingolstadt (DE)

(73) Assignee: AUDI AG, Ingolstadt (DE)

(21) Appl. No.: 16/500,714

(22) PCT Filed: Jan. 15, 2018
(86) PCT No.: PCT/EP2018/050900

§ 371 Date: Oct. 3, 2019

(30) Foreign Application Priority Data
Apr. 18, 2017 (DE) 10 2017 206 480.3

(51) Int. Cl. B60S 1/08; G08C 17/02; G01N 27/22

(52) U.S. Cl. CPC B60S 1/0825; G01N 27/223; B60S 1/0844; G08C 17/02

(57) ABSTRACT

The invention relates to a method for operating a capacitive motor vehicle rain sensor, which has an electrically conductive structure and which is designed to generate an analog measurement signal corresponding to a rain intensity and output same as an output signal, wherein the method has the steps of detecting at least one interference signal, which causes an interference with the analog measurement signal and leads to a measurement signal affected by interference, at least partly suppressing the interference of the measurement signal affected by interference in at least one signal processing step on the basis of the detected interference signal and an output of an at least partially interference-suppressed output signal. The invention also relates to a device for carrying out the method and to a motor vehicle comprising the device.

### TECHNICAL FIELD

The present disclosure relates to a method for operating a capacitive rain sensor in a motor vehicle, which sensor is designed to generate an analog measurement signal corresponding to a rainfall intensity in at least one measurement, and to output a correlated output signal. The present disclosure also includes a measurement signal interference suppression device with a corresponding capacitive rain sensor and a motor vehicle with a corresponding measurement signal interference suppression device.

### BACKGROUND

Capacitive rain sensors, which can be properly designed to perform rain measurements as well as to serve as antennas for radio signals, are known. Antennas that are applied to a transparent laminate are also known. The problem with this is that the result of the rain measurement is at least partly affected by radio signals.

EP 2 256 856 A1 discloses a transparent, planar device for receiving and/or transmitting electromagnetic radiation along with at least one additional operation. The additional operation consists of measuring a physical property, such as an electrical capacitance. An additional operation is the function of a heating panel and/or a moisture-sensitive sensor element, in particular a rain sensor. To separate the two operations, the electrical signals deriving from the rain sensor operation are separated by a frequency filter from the signals deriving from the operation of the receiver and/or transmitter.

DE 297 08 536 U1 discloses an antenna device for radio communication with motor vehicles. The antenna is constituted of electrically conductive tracks of a printed circuit board. The printed circuit is preferably contained in a separate enclosure made of a plastic material, which enclosure has a profile that is sealed well by a glass surface and which can be secured to the glass surface with a suitable adhesive. The antenna device performs no other functions.

WO 2013/091961 A1 discloses a composite pane with an antenna structure and an integrated button. This provides for two electrically conductive structures, one of which is an antenna conductor and the other a button. This is particularly a contactless button. No other functionality is disclosed aside from the button.

By integrating a rain sensor and a transmitting and receiving device for electromagnetic radiation or because of the presence of an antenna device next to a rain sensor, the result of the measurement of the rain sensor is disturbed by the transmitted or received electromagnetic radiation of the transmitting and receiving device.

It is the object of the present disclosure to provide a method that makes it possible to operate a capacitive rain sensor with high accuracy of the measurement results, even in the event of disturbances due to interference signals, and to make available a measurement signal interference suppression device and a motor vehicle with such a measurement signal interference suppression device. This should allow the capacitive rain sensor to measure the rainfall intensity accurately.

### SUMMARY

The object of the present disclosure is achieved according to the independent claims. Other advantageous developments are described by the dependent claims, the following description, and the drawings of the application.

The present disclosure describes a method for operating a capacitive rain sensor. The latter has at least one electrically conductive structure. The rain sensor is in particular used in a motor vehicle as well as in a train. The rain sensor outputs an analog measurement signal, which corresponds to a rainfall intensity, in at least one measurement. This means that the value of the output signal, i.e. the analog measurement signal that is issued, differs depending on the intensity of the rain, for example high in heavy rain, low in low rain and zero in no rain.

The present disclosure provides the following method to render the output measurement signal, i.e. the output signal, robust against the effects of interference signals. At least one interference signal, which causes a malfunction of the analog measurement signal, is detected in a first step a). The interfering signal causes the measured signal to be faulty, which means that the value of the measured signal is a distorted value, i.e. does not correspond to the value which the rain sensor would output in the absence of an interfering signal. The interference signal is detected by suitable means, for example by means of an antenna for a radio signal. This process step has the advantage that the interference signal is thereby known exactly. It is thus also known exactly in what way the analog measurement signal is disrupted. The interference signal can thus have the same frequency or a very similar one, in particular a frequency that differs by less than 10% from the frequency at which the capacitive rain sensor is operated.

The interference-prone measuring signal is at least partially suppressed in step b) of the method according to the present disclosure. This is accomplished in a signal processing step based on the previously detected interference signal. The signal processing step is thus designed to compensate, at least partially, for the interference with the measurement signal caused by the interference signal. This means that knowledge of the detected interference signal makes it possible to determine the nature and the size and the of the analog measurement signal that is corrupted. The detected signal is thus used to compensate for the effect of the interference signal on the measurement signal in the signal processing step. The process of compensation or interference suppression then takes place at least to a degree that ensures that the interference-suppressed measurement signal contains the correct rainfall information. The interference signal is thus preferably fully compensated, which means that the analog measurement signal is preferably fully interference-suppressed, i.e. it corresponds to the analog measurement signal that would have been measured in the absence of the interference signal. However, since it is known that measurements or the detection of signals, such as the interfering signal, always leads to measurement inaccuracies, it is assumed that the analog measurement signal is usually only partially interference suppressed. The greatest possible part of the interference signal is preferably compensated; in particular at least 80% of the interference signal is compensated.

An output of an at least partially interference suppressed output signal is output in step c) of the method according to the present disclosure. This means that the analog measurement signal is output as the output signal after it has been at least partially interference-suppressed in a signal processing step. The output signal is thus the at least partially interference-suppressed measurement signal. This process step has the advantage that the analog measurement signal of the rain sensor is known without it being falsified, i.e. without the influence of an interfering signal. This ensures that very accurate conclusions about the actual rain intensity can be deduced from the output signal. Knowledge of the actual, absolute rain intensity is important for some applications, for example to control a windshield wiper system of a motor vehicle or as information for weather services.

In a further embodiment of the method, the measured interference signal is an electromagnetic radio signal, in particular a transmitted and/or received signal. The electromagnetic radio signal may, for example, be transmitted from a mobile phone. This electromagnetic radio signal can be detected by means of a suitable antenna. Such an antenna is, for example, a mobile radio antenna and/or an indoor antenna and/or a relay for amplifying radio signals in and/or on a vehicle. The detected signal is available for the further process steps. In this case, the signal processing step is performed by a subtractor. The subtractor subtracts the at least one interference signal detected previously from the interfering measurement signal. The result of the signal processing step is a difference signal. This difference signal is output as the at least partially interference-suppressed output signal. In other words, this embodiment describes how an interference signal, which is added to the analog measurement signal as a disturbance, is again subtracted from the analog measurement signal affected by interference in the signal processing step. The difference signal is thus the analog measurement signal with a value that at least approximately corresponds to the value that would have been output without the presence of an interference signal. The value of the difference signal preferably corresponds exactly to the value of the analog measurement signal that would have been output without the presence of an interference signal. It is the advantage of this embodiment that the interference signal is detected and thus known and that the interference signal can also be offset very well again. The value of the at least partially interference-suppressed output signal thus corresponds very closely to the value of the analog measurement signal as it would be without the presence of an interference signal. The big advantage of subtracting the interfering signal is that, although it can be in the same frequency range as an operating frequency of the capacitive rain sensor, the interference can still be offset.

An embodiment of the process takes into account that the analog measurement signal of the rain sensor can also be disrupted by sources other than electromagnetic radio signals. An example of such an effect is a hand movement in the vicinity of the rain sensor, which alters its capacitance and thus also the value of a measuring signal in a measurement. In the further embodiment of the method, reference hand movements and their effect on the analog measurement signal are therefore first captured by means of a camera in step i) and a correction rule, by means of which such a disturbance by a respective hand movement is compensated, is created in step ii). At least one hand movement, which produces a capacitance of the capacitive rain sensor at a constant rain intensity, is therefore detected in step i). This means that a change in capacitance is solely attributable to the hand movement, and the hand movement thus represents an interference signal. A plurality of corresponding changes in the capacitance are preferably detected via a plurality of reference hand movements. The important parameters are: The size of the hand and/or the position of the hand and/or the location of the hand and/or the distance of the hand from the rain sensor. A correction rule, which compensates for a respective change of capacitance, is created in step ii) by means of the detected changes in the capacitance of the rain sensor for a respective reference hand movement, so that the analog measurement signal can be output again as it would have been output in the absence of an interfering hand movement. A correction rule can, for example, be a simple table, which provides a value to be subtracted from the faulty measurement signal and/or scales the value of the faulty measurement signal by a specific factor. The correction rule can also be a formulaic calculation rule which has been established on the basis of the effects of a large number of reference hand movements on respective changes in capacitance. The advantage of this embodiment of the process is that it is not only possible to compensate for electromagnetic interference signals by this means, but it is also possible for a measurement signal of the rain sensor disturbed by a hand movement to be at least partially suppressed. At least one hand movement, which disturbs the measurement of the rain sensor, is detected for this purpose by means of a camera in step a). The camera is designed so that an optical detection range of the camera detects at least the domain in which the capacitive rain sensor is positioned. The at least one detected hand movement is compared in step b) with reference hand movement based on the aforesaid parameters, and a reference hand movement is selected by means of a similarity criterion. The similarity criterion, in turn, includes at least one of the aforesaid parameters, e.g. a size of one hand of the detected hand movement deviates by less than 20% from a size of a hand of a detected reference hand movement or a position of a hand of the detected hand movement deviates by less than 2 cm from a position of a hand of a detected reference hand movement. The analog measurement signal of the capacitive rain sensor is at least partially interference-suppressed and output in step c) as an at least partially interference-suppressed output signal by means of the correction instructions corresponding to the reference hand movement.

An embodiment of the method provides that the electrically conductive structure of the capacitive rain sensor is used for at least two different modes of operation. On the one hand, a rain intensity is measured by means of the electrically conductive structure, which corresponds to the functionality of the rain sensor. On the other hand, the electrically conductive structure is also used to transmit and/or receive an electromagnetic radio signal. The electrically conductive structure thus also serves as an antenna. This is, in particular, possible in that the electrically conductive structure is configured in a suitable geometric form, which depends on the frequency of the radio signal that is to be transmitted and/or received. The antenna formed by the electrically conductive structure may, for example, be used to transmit and/or receive mobile radio signals such as GSM or LTE signals. This has the advantage that a mobile radio signal, which represents the interference signal of the rain sensor, is seen directly by the rain sensor in this case. This means that the detection of the interference signal as of step a) can be performed directly within the rain sensor. A signal processing device, which can perform the process step b), so that the capacitive rain sensor can output the at least partially suppressed output signal at an output, is advantageously also provided within the rain sensor in this case. This has the advantage that an integrated solution is provided, which gets by without further components, such as an external antenna for detecting an interference signal.

An embodiment of the method allows for the at least one interference signal and/or an additional interference signal to be transmitted and/or received not only via the electrically conductive structure of the capacitive rain sensor acting as the first antenna, but additionally via at least or exclusively a second and/or additional antenna. This means that the same interfering signal is either transmitted and/or received via both the electrically conductive structure of the rain sensor and via an additional antenna, or that at least one of two or more different interfering signals is transmitted and/or received via the electrically conductive structure of the capacitive rain sensor, and another of the interfering signals is transmitted and/or received via an antenna other than the capacitive rain sensor. The electrically conductive structure of the rain sensor may, for example, be configured to receive radio signals, and an external antenna, for example a mobile radio antenna that is integrated in a motor vehicle, may be configured to transmit and/or receive mobile radio signals. This embodiment has the advantage that different electromagnetic signals, i.e. radio signals of different frequencies, can be detected and thus used to at least partially suppress an interference of the analog measurement signal by the rain sensor.

An embodiment of the process provides that the at least partially interference-suppressed output signal is transmitted via an antenna and is received by a central receiving device. The central receiving device interprets the output signal as current rainfall information and outputs it accordingly as information. The central receiving device may, for example, be a weather service. This has the advantage that such a weather service has real-time rainfall information at a current position of a motor vehicle. An antenna by which the interference-suppressed output signal is transmitted may be the electrically conductive structure of the capacitive rain sensor and/or it may be another antenna of the motor vehicle. In the event that the output signal is transmitted directly via the electrically conductive structure of the rain sensor has the advantage that it is possible to dispense with an additional external antenna and with a connection to this antenna. The rain sensor can thus be configured as an integrated component that does not require any external connections. The advantage that arises when an antenna of the motor vehicle is used for transmission is that existing transmission devices can be used. This means, for example, that it is possible to dispense with an additional embodiment of a transducer and/or a transmission signal controller.

As has been mentioned, the present disclosure also includes a measurement signal interference device with a capacitive rain sensor, which is designed to generate an analog measurement signal depending on rainfall intensity. The measurement signal interference device has at least one electrical input and at least one electrical output. A signal processing device of the measurement signal interference device is designed to at least partially suppress an analog measurement signal of the capacitive rain sensor based on a detected interference signal. The detected measurement signal can be supplied via the electrical input or the electrically conductive structure of the capacitive rain sensor itself. In this event, it is also possible to dispense with an electrical input. It is, in particular, also possible to connect a camera to the electrical input, by means of which camera interfering hand movements or other objects influencing the capacitance of the signal processing device are, for example, made available. The output of the measurement signal interference device is designed to provide an at least partially interference-suppressed output signal. This output signal can then, for example, be transmitted by means of another antenna. It is also possible to send the output signal directly via the electrically conductive structure of the capacitive rain sensor; it is then possible then to dispense with the electrical output.

The present disclosure also includes a motor vehicle, which is equipped with the measurement signal interference suppression device according to the present disclosure. An antenna and/or a camera of the motor vehicle can, for example, be connected to an electrical input of the measurement signal interference suppression device. This has the advantage that existing devices of the motor vehicle can be used for the detection step of the method according to the present disclosure and the respectively detected interference signal of the signal processing device of the measurement signal interference device can be provided via the electrical input.

The present disclosure also includes further embodiments of the measuring signal filtering device and the motor vehicle according to the present disclosure, which embodiments have features such as those previously described in connection with the further embodiments of the process according to the present disclosure. It is for this reason that the relevant further embodiments of the measuring signal filtering device and the motor vehicle according to the present disclosure are not described again herein.

### BRIEF DESCRIPTION OF THE DRAWINGS/FIGURES

Exemplary embodiments of the present disclosure are described below. In the drawings:

FIG. 1 depicts a flow diagram of an example method according to example embodiments of the present disclosure;

FIG. 2 depicts a schematic representation of the measurement signal interference suppression device according to example embodiments of the present disclosure; and

FIG. 3 depicts a schematic representation of a motor vehicle with a measurement signal interference suppression device according to example embodiments of the present disclosure.

### DETAILED DESCRIPTION

The exemplary embodiments explained below are preferred embodiments of the present disclosure. In the exemplary embodiments, the described components of the embodiments each constitute individual features of the embodiments of the present disclosure to be considered independently of one another, each of which independently further refines embodiments of the present disclosure, and are therefore also to be considered as part of the present disclosure individually or in a combination different from that shown. In addition, features of the present disclosure other than those already described may be added to the embodiments described.

In the drawings, elements having the same function are respectively provided with the same reference numerals.

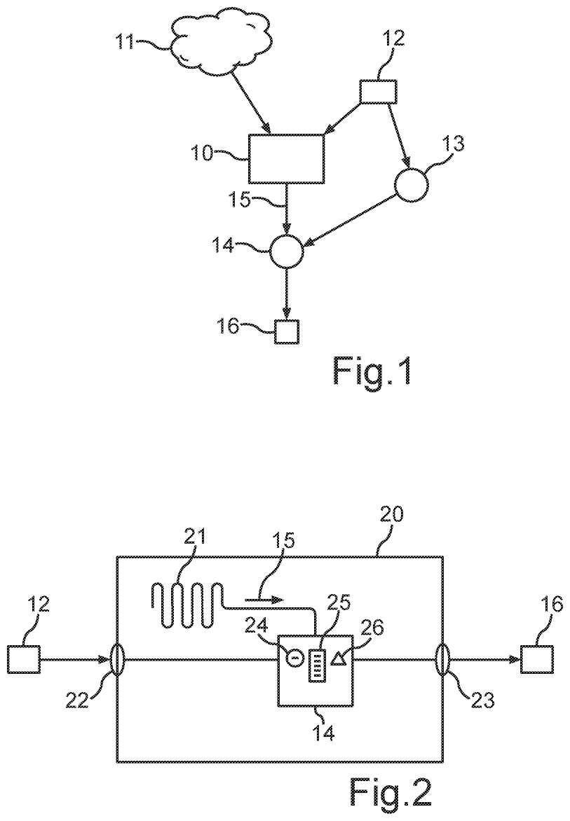

FIG. 1 shows a schematic representation of the process. In this case, a capacitive rain sensor 10 measures a rainfall intensity 11. Information about the rainfall intensity 11 is output by the capacitive rain sensor 10 via an analog measurement signal 15. This analog measurement signal is disturbed by an interference signal 12. The interference signal 12 affects the capacitive rain sensor 10 on the one hand and is, on the other hand, detected by a detection device 13. The measurement signal 15 is disturbed by the interfering signal 12 and the interfering signal 12 detected by the detecting device 13 is respectively transmitted to a signal processing device 14. The signal processing device 14 uses the information on the detected interference signal 12 to suppress the interference-prone analog measurement signal 15. The signal processing device 14 outputs an at least partially interference-suppressed output signal 16 as a result.

FIG. 2 shows a schematic representation of a measurement signal interference device 20. As a capacitive rain sensor 10, the measurement signal interference device 20 has an electrically conductive structure 21. The latter transmits the analog measurement signal 15, which is disturbed by the interference signal 12, to the signal processing device 14. The detected interference signal 12 is supplied at an electrical input 22, so that the signal processing device 14 is available. The measurement signal interference suppression device 20 outputs the at least partially suppressed output signal 16 via an electrical output 23. The signal processing device 14 has a subtractor 24, a correction rule 25 and a similarity criterion 26 at its command.

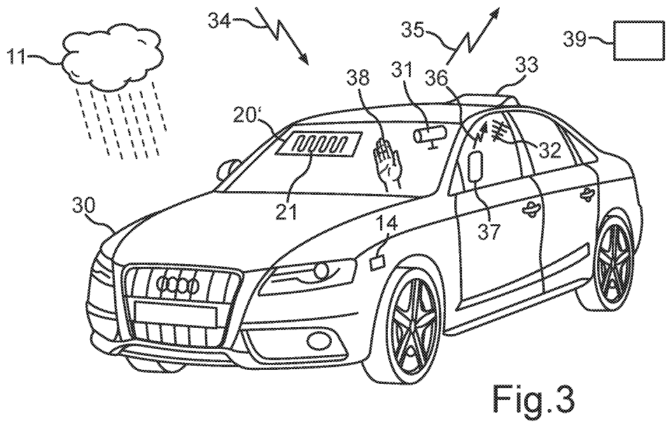

FIG. 3 shows a schematic representation of a motor vehicle 30, which is equipped with a measurement signal interference suppression device 20′. This device can be used to measure a rainfall intensity 11. The motor vehicle 30 has a camera 31, an interior antenna 32 and a motor vehicle antenna 33 as devices for detecting interference signals. An interference signal is an electromagnetic reception signal 34 or transmission signal 35, a mobile radio signal 36, which is transmitted by a mobile device 37 located in the motor vehicle 30 or a hand movement 38. The motor vehicle 30 has a signal processing device 14 for carrying out the signal processing step. The motor vehicle 30 can send information, for example the output signal 16, to an external server 39 via the transmission signal 35.

In one embodiment, the interfering signal 12 is an electromagnetic radio signal. The latter is forwarded to the signal processing device 14 through a detection device 13, such as an antenna, via the electrical input 22 of the measurement signal interference device 20. The capacitive rain sensor outputs an analog measurement signal 15, which is disturbed by the interference signal 12. The measurement signal 15 is also sent to the signal processing device 14. The subtractor 24 subtracts the detected interference signal 12 from the analog measurement signal 15 affected by interference. The interference-suppressed measurement signal 15 is issued as an output signal 16 via the electrical output 23. As a result, the output signal 16 is ideally completely interference-suppressed or at least partially interference-suppressed, so that the output signal 16 contains the information on the rain intensity 11 detected by the rain sensor 21 in the same way as the information the output signal 16 would contain if no interference signal 12 were present or if the deviation from this case were smaller than 10%.

In another exemplary embodiment, the interference signal 12 is provided by a hand movement 38. The hand movement 38 may, for example, be a hand movement by a driver of the motor vehicle 30. In this event, the hand movement 38 is detected by the camera 31 if it takes place at least in a predetermined proximity of the measurement signal interference device 20′ and interferes with a measurement of the capacitive rain sensor 21. In this event, the interference signal 12 is detected by the camera 31 and is passed on to the signal processing device 14. In the signal processing step, the detected hand movement 38 is compared with other previously recorded hand movements via a similarity criterion 26 and a previously recorded hand movement is selected by means of the similarity criterion 26 whose interference effect on the analog measurement signal 15 has been detected and for which a correction rule 25, which describes the corrected interference of the analog measuring signal 15, has been created. The influence of a hand movement 38, which is recorded by the camera 31, on the measurement of the capacitive rain sensor 21 is thus known to the signal processing device 14 and can be compensated by means of the correction rules 25, so that the output signal 16 again represents the analog measurement signal 15 in the same way as the capacitive rain sensor 21 would represent the output 38 in the absence of the hand movement.

In a further embodiment, the interference signal 12 is supplied by a mobile radio signal 36 from a mobile device 37. The interference signal is detected by the indoor antenna 32 and supplies to the signal processing device 14. In another exemplary embodiment, the mobile radio signal of a car telephone is transmitted as a transmission signal 35 via the motor vehicle antenna 33, with the transmission signal 35 representing the interference signal 12. Due to the fact that the signal is transmitted by the motor vehicle antenna 33, it is already known for this process step, i.e., it does not have to be detected again separately, but can be made immediately available to the signal processing device 14. In another embodiment, the interference signal 12 is an electromagnetic reception signal 34, for example a mobile radio signal or a radio signal. This received signal 34 can either be detected by the electrically conductive structure 21, that is to say the capacitive rain sensor itself, and can be made available as an interference signal 12 of the signal processing device 14, or detected by the motor vehicle antenna 33. In this event, the motor vehicle antenna 33 is connected to the measurement signal interference device 20′ of the motor vehicle 30.

In one exemplary embodiment, the measurement signal interference device 20′ of the motor vehicle 30 corresponds to the measurement signal interference device 20 of FIG. 2, i.e., the signal processing device 14 and the capacitive rain sensor 21 are also made available in the measurement signal interference device 20′. In another exemplary embodiment, the measurement signal interference device 20′ has the electrically conductive structure 21 as well as the electrical input 22 and the electrical output 23. The signal processing device 14 is, however, made available in the motor vehicle 30, outside the measurement signal interference device 20. In doing so, the signal processing device 14 may, for example, be realized by an on-board computer of the motor vehicle 30.

The present disclosure shows how capacitive rain sensors, or their measured signal values, can be made robust against interference signals by the method according to the present disclosure. It is above all the advantage of a capacitive rain sensor, which is robust against interference signals, that it provides more accurate information about a current rainfall intensity than, for example, optical rain sensors. This is needed in order to use the rainfall intensity information of the capacitive rain sensor, for example for a weather service. The capacitive rain sensor using the process according to example embodiments of the present disclosure can therefore send very accurate rainfall intensity information to an external service, such as a weather service in real time. Interference signals which impair and distort the measurement result of the capacitive rain sensor, for example electromagnetic radio signals such as UMTS, GSM or LTE signals, are compensated by the method according to the present disclosure. The full potential of a capacitive rain sensor, which allows for a very accurate rain intensity measurement is thus provided. In doing so, the capacitive rain sensor can itself be configured as an antenna that sends or receives the interference signal, so that it is captured directly by the rain sensor and is known and can thus be filtered out of the measurement rather than entering into the rain measurement as undefined noise or interference. The advantages are a reduction in component costs by reducing complexity and a variety of alternatives. A capacitive rain sensor operated in this way only makes possible such a rain measurement when needed for certain applications, such as a host service for sending weather data to a backend. A capacitive rain sensor has the advantage that it can also be used to draw conclusions about residual amounts of salt in the water, for example, to describe how much salt is on a road in winter, so one knows whether salt should be scattered on the road or not in order to protect traffic during frost.

The examples show overall how a capacitive rain sensor can be operated via the present disclosure, so that it outputs such precise and exact rainfall intensity information, even in the presence of interference signals, that it can be used for services such as weather services. To accomplish this, the measuring signal of the capacitive rain sensor is processed as a function of the detected interference signal, so that the effect of the interference signal is compensated.

1.-8. (canceled)

9. A method for operating a capacitive rain sensor for a motor vehicle, the capacitive rain sensor having an electrically conductive structure, the capacitive rain sensor configured to produce an analog measurement signal corresponding to a rain intensity in at least one measurement, the method comprising the following steps:
a) detecting at least one interference signal that causes interference with the analog measurement signal, wherein the at least one interference signal is an electromagnetic radio signal that is a radio transmission signal;
b) at least partially suppressing the analog measurement signal using at least one signal processing technique, the at least one signal processing technique determined based at least in part on the detected at least one interference signal, the at least one signal processing technique comprising subtracting the detected at least one interference signal from the analog measurement signal; and
c) outputting the at least partially suppressed analog measurement signal as an output signal;
wherein the capacitive rain sensor comprises a first antenna formed by the electrically conductive structure, and measures a rain intensity, and wherein the electromagnetic radio signal is provided by the first antenna formed by the electrically conductive structure.

10. The method according to claim 9, wherein detecting the at least one interference signal comprises detecting, by at least one camera, a hand movement; and
wherein the method further comprises:
detecting, using at least one camera, at least one reference hand movement, and a change of a capacitance of the capacitive rain sensor caused by the at least one reference hand movement at a constant rain intensity;
creating a correction rule for the at least one reference hand movement, wherein the correction rule compensates for the detected change in the capacitance of the capacitive rain sensor caused by the at least one reference hand movement; and
assigning the detected hand movement to a reference hand movement based at least in part on a similarity criterion, the similarity criterion comprising at least one of a hand position or a hand size;
wherein at least partially suppressing the analog the measurement signal comprises at least partially suppressing the analog measurement signal based at least in part on the correction rule created for the reference hand movement assigned to the detected hand movement.

11. The method according to claim 9, further comprising:
transmitting the output signal via at least one of the first antenna formed by the electrically conductive structure of the capacitive rain sensor or a second antenna of the motor vehicle; and
outputting, by a central receiving device, the output signal as current rain strength information.

12. The method according to claim 9, further comprising controlling a windshield wiper system of the motor vehicle based at least in part on the output signal.

13. The method according to claim 9, wherein the first antenna is configured to transmit or receive at least one of GSM or LTE mobile radio signals.

14. A motor vehicle comprising a capacitive rain sensor, the capacitive rain sensor having an electrically conductive structure, the capacitive rain sensor configured to produce an analog measurement signal corresponding to a rain intensity in at least one measurement, the motor vehicle further comprising one or more computing devices configured to:
a) detect at least one interference signal that causes interference with the analog measurement signal, wherein the at least one interference signal is an electromagnetic radio signal that is a radio transmission signal;
b) at least partially suppress the analog measurement signal using at least one signal processing technique, the at least one signal processing technique determined based at least in part on the detected at least one interference signal, the at least one signal processing technique comprising subtracting the detected at least one interference signal from the analog measurement signal; and
c) output the at least partially suppressed analog measurement signal as an output signal;
wherein the capacitive rain sensor comprises a first antenna formed by the electrically conductive structure, and measures a rain intensity, and wherein the electromagnetic radio signal is provided by the first antenna formed by the electrically conductive structure.

15. The motor vehicle according to claim 14, wherein detecting the at least one interference signal comprises detecting, using at least one camera, a hand movement; and
wherein the one or more computing devices are further configured to:
detect at least one reference hand movement, and a change of a capacitance of the capacitive rain sensor caused by the at least one reference hand movement at a constant rain intensity;
create a correction rule for the at least one reference hand movement, wherein the correction rule compensates for the detected change in the capacitance of the capacitive rain sensor caused by the at least one reference hand movement; and
assign the detected hand movement to a reference hand movement based at least in part on a similarity criterion, the similarity criterion comprising at least one of a hand position or a hand size;
wherein at least partially suppressing the analog the measurement signal comprises at least partially suppressing the analog measurement signal based at least in part on the correction rule created for the reference hand movement assigned to the detected hand movement.

16. The motor vehicle according to claim 14, wherein the one or more computing devices are further configured to:
transmit the output signal via at least one of the first antenna formed by the electrically conductive structure of the capacitive rain sensor or a second antenna of the motor vehicle; and
wherein a central receiving device is configured to output the output signal as current rain strength information.

17. The motor vehicle according to claim 14, wherein the one or more computing devices are further configured to control a windshield wiper system of the motor vehicle based at least in part on the output signal.

18. The motor vehicle according to claim 14, wherein the first antenna is configured to transmit or receive at least one of GSM or LTE mobile radio signals.
